(19) United States
(12) Patent Application Publication
(10) Pub. No.: US 2006/0005039 A1
(43) Pub. Date: Jan. 5, 2006

(54) Authentication control system and method thereof

(75) Inventor: Chia-Chang Hsieh, Tainan City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: BENQ Corporation

(21) Appl. No.: 11/136,150

(22) Filed: May 24, 2005

(30) Foreign Application Priority Data
May 26, 2004 (TW) 93114907

(51) Int. Cl. H04K 1/00

(52) U.S. Cl. 713/183

(57) ABSTRACT

A system and method thereof for authentication control are provided. A display device displays a password input screen. The password input screen comprises multiple display characters being displayed at a coordinate location individually. A storage device stores at least one password configuration record individually comprising a detection character and coordinate data thereof. A processing unit compares the display characters determine an access status when each detection character is the same as one of the display characters and the corresponding coordinate data corresponds to the corresponding coordinate location.

### BACKGROUND

The present invention relates to authentication management technology, and more particularly, to a system and method thereof for authentication control.

Various methods, such as password, digital certification, IP address restriction, and the like, are utilized in conventional authentication control systems. These methods verify whether users or remote computer systems have rights to access hardware devices, e.g., projectors, mobile phones, personal digital assistants (PDAs), hard drives, digital cameras, computers, or others, or software systems. In password verification, it is determined whether an input character string matches a correct password, if so, permission is granted to access hardware devices or software systems. When a password is input, the mask symbols, e.g., “*”, “#”, and the like, are displayed to prevent unauthorized acquisition of the password by others.

FIG. 1 is a diagram of a conventional password input screen. A password input screen 21 contains a user identity input field 21a, a password input field 21b and a confirmation button 221c. Ten “*” characters displayed in the password input field 21b are used to hide a correct password. Although the solution is adequate, in most situations, the correct password can be guessed by monitoring the password input screen and user keystrokes. In view of these limitations, a need exists for a system and method of authentication control reducing the risk of password theft.

### SUMMARY

An embodiment of an authentication control system comprises a display device, a storage device and a processing unit. The display device displays a password input screen. The password input screen comprises multiple display characters displayed individually at coordinate locations. The storage device stores at least one password configuration record individually comprising a detection character and coordinate data thereof. The processing unit compares the display characters to verify that each detection character is the same as one of the display characters and that the corresponding coordinate data corresponds to the corresponding coordinate location.

Preferably, the processing unit directs the display device to generate an initial password input screen. The initial password input screen comprises multiple horizontal/vertical rotatable fields individually comprising the display characters. Each coordinate location of the display character is randomly generated. The processing unit directs the display device to select a predetermined field. The processing unit receives a field selection-signal with a field identity and directs the display device to select field corresponding to the field identity. The processing unit additionally receives a rotation signal with a direction and directs the display device to rotate all the display characters in the selected field to the selected position.

An embodiment of an authentication control method comprises acquiring a password input screen with multiple display characters displayed at a coordinate location individually, acquiring at least one password configuration record having a detection character and coordinate data thereof, and disabling the password input screen if each of the display characters corresponding to the detection characters is displayed at the coordinate location corresponding to the coordinate data.

Preferably, an embodiment of an authentication control method further comprises generating an initial password input screen with multiple horizontal/vertical rotatable fields comprise the display characters individually, each coordinate location of the display characters being randomly generated, selecting one of the fields, receiving a field selected signal with a field identity, selecting one of the fields corresponding to the field identity, receiving a rotation signal with a direction, and rotating all the display characters in the selected field to the selected position.

Computer-readable storage media for storing computer programs also are disclosed for performing an embodiment of a method of authentication control.

Preferably, when the field is selected, a rectangle is displayed around the field, an arrow image or the like points to the field, colors of the characters and background in the field alternate, and colors or fonts of characters in the field change.

### BRIEF DESCRIPTION OF THE DRAWINGS

Embodiments of invention can be more fully understood by reading the subsequent detailed description and examples of embodiments thereof with reference made to the accompanying drawings, wherein:

FIG. 1 is a diagram of a conventional password input screen;

FIG. 2 is a diagram of an embodiment of a hardware environment;

FIG. 3 is a diagram of exemplary password configuration records;

FIG. 4 shows an embodiment of a method of authentication control;

FIG. 5 is an exemplary initial password input screen;

FIGS. 6a to 6h are exemplary password input screens in various aspects;

FIG. 7 is a diagram of an embodiment of a storage medium for a computer program providing a method of authentication control.

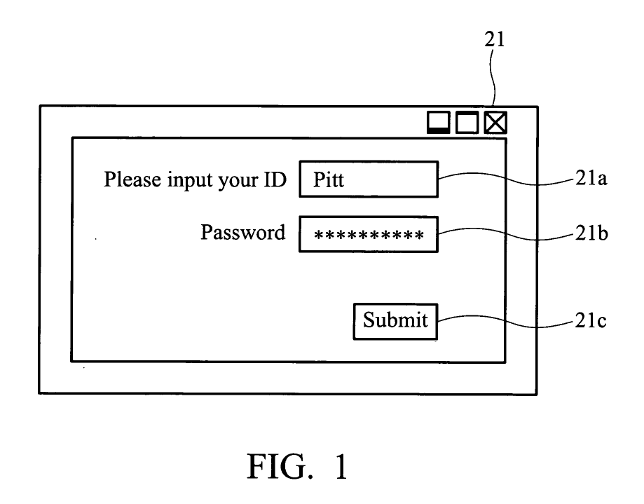

### DETAILED DESCRIPTION

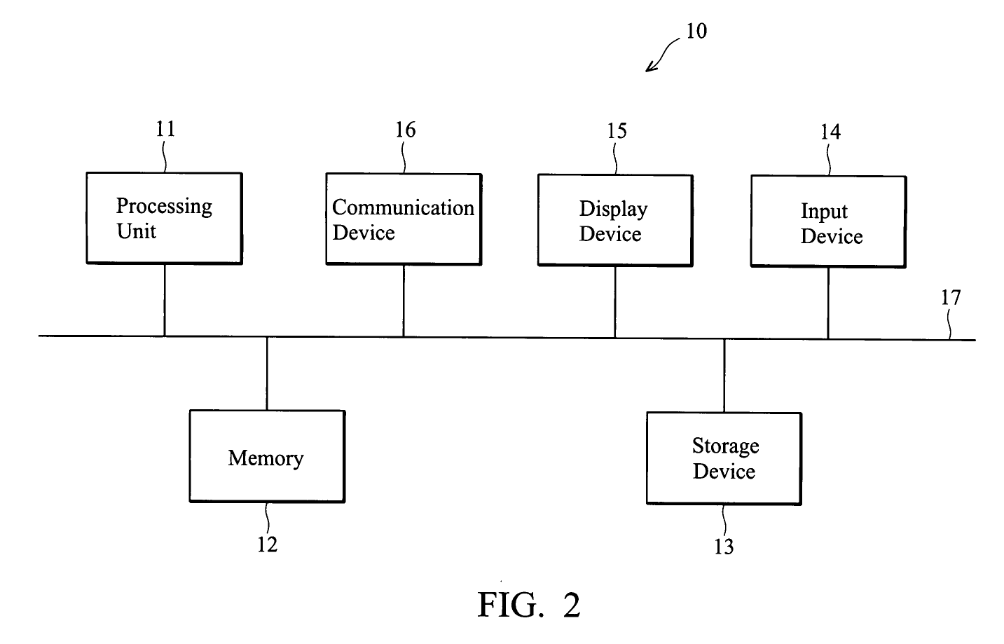

FIG. 2 is a diagram of an embodiment of a hardware environment. A brief, general description of suitable computer hardware and a suitable computing environment in conjunction with which at least some embodiments may be implemented is given in FIG. 2. The hardware environment of FIG. 2 includes a processing unit 11, a memory 12, a storage device 13, an input device 14, a display device 15 and a communication device 16. The processing unit 11 is connected by buses 17 to the memory 12, storage device 13, input device 14, display device 15 and communication device 16 based on Von Neumann architecture. The processing unit 11 comprises a single central processing unit (CPU), a micro processing unit (MPU) or multiple processing units, commonly referred to as a parallel processing environment. The memory 12 is preferably a random access memory (RAM), but may also include read-only memory (ROM) or flash ROM. The memory 12 preferably stores program modules executed by the processing unit 11 to perform authentication control functions. Generally, program modules include routines, programs, objects, components, or others, that perform particular tasks or implement particular abstract data types. Moreover, those skilled in the art should understand that at least some embodiments may be practiced with other computer system configurations, including hand-held devices, multiprocessor-based, microprocessor-based or programmable consumer electronics, network PC's, minicomputers, mainframe computers, projectors, and the like. Some embodiments may also be practiced in distributed computing environments where tasks are performed by remote processing devices linked through a communication network. In a distributed computing environment, program modules may be located in both local and remote memory storage devices. The storage device 13 may be a hard drive, magnetic drive, optical drive, a portable drive, or nonvolatile memory drive. The drives and their associated computer-readable media (if required) provide nonvolatile storage of computer-readable instructions, data structures, program modules and password configuration records.

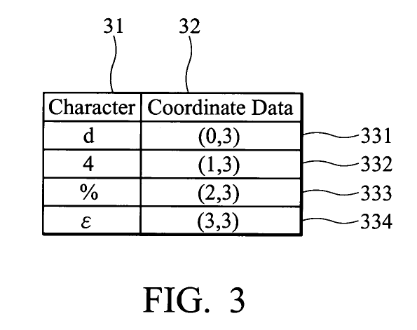

The processing unit 11, controlled by program modules received from the memory 12 and from an operator through the input device, directs authentication control functions. The storage device 13 may comprise a database system, a file, or the like, for storing multiple password configuration records. FIG. 3 is a diagram of exemplary password configuration records, and includes four records 331 to 334. Each password configuration record stores information regarding which character must be displayed by the display device 15 at a particular coordinate, and preferably comprises two fields, a character 31 and coordinate data 32. The coordinate data 32 may be a two-dimensional coordinate or a multi-dimensional coordinate. The implementation of the password configuration records described above is not limited to a single table/file, but also to multiple related tables/files. Referring to records 331 to 334, characters “d”, “4”, “%” and “ε” respectively correspond to two-dimensional coordinates (0,3), (1,3), (2,3) and (3,3).

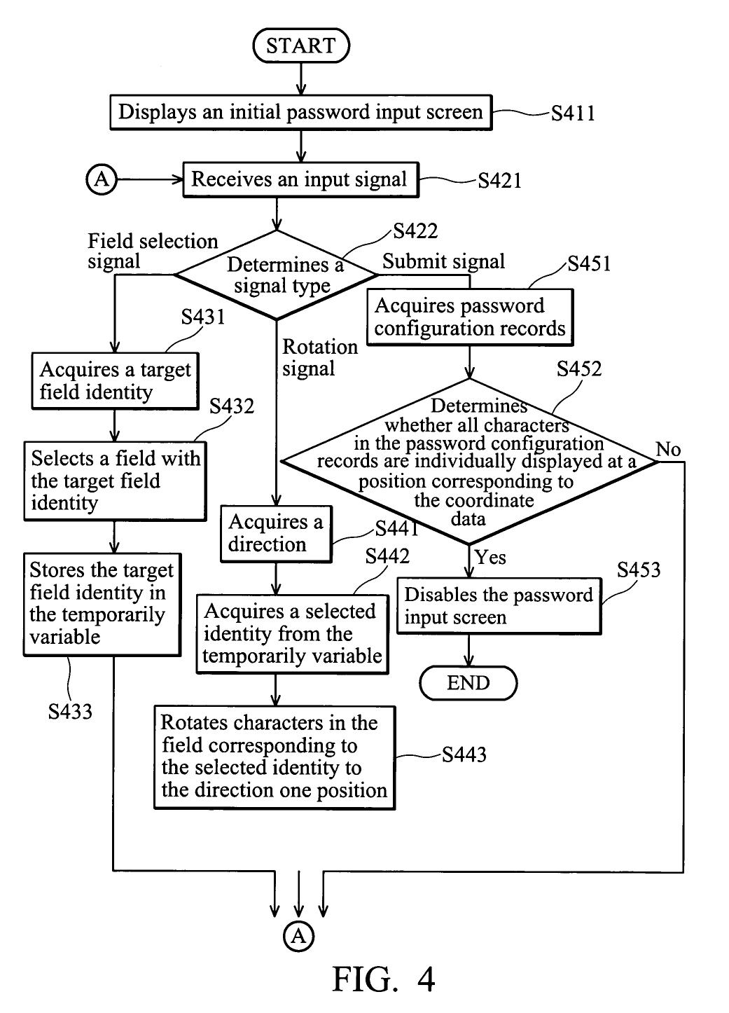

The memory 12 comprises program modules for performing an authentication control method. FIG. 4 shows an embodiment of a method of authentication control. In step S411, an initial password input screen is displayed. The password input screen may comprise multiple horizontally or vertically rotatable fields. Each field comprises multiple randomly generated characters, and each character can be an alphanumeric character, symbol, or image icon. A predetermined field is selected for character rotation. When the field is selected a rectangle is displayed around the field, an arrow image or the like points to the field, colors of the characters and background in the field alternate, and colors or fonts of characters in the field change. In addition, the identity of the selected field is stored in a temporary variable.

In step S421, an input signal is received from the input device 14. In step S422, a signal type of the input signal is determined. If the signal type is a field selection signal, a rotation signal and a submit signal, the process respectively proceeds to step S431, S441 and S451. In step S431, a target field identity is acquired, thereafter, in step S432, a field corresponding to the target field identity is selected, and finally, in step S433, the target field identity is stored in the temporary variable. In step S441, a direction is acquired. In step S442, a selected identity is acquired from the temporary variable, and finally, in step S443, characters in the field corresponding to the selected identity are rotated to the selected position. In step S451, the password configuration records are acquired. In step S452, the method determines whether all characters in the password configuration records are individually displayed at a position corresponding to the coordinate data, if so, the process proceeds to step S453 to disable the password input screen, otherwise, to step S421 to receive another signal.

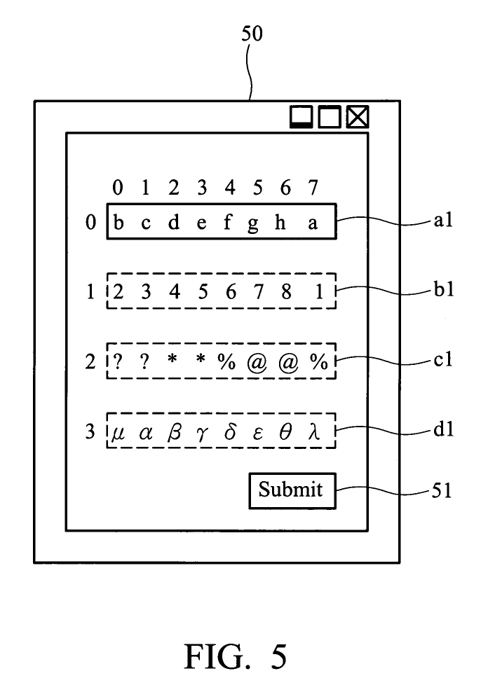

A method of an embodiment of the invention can be more fully understood by reading the subsequent detailed examples. FIG. 5 is an exemplary initial password input screen. First, referring to step S411, an initial password input screen as shown in FIG. 5 is generated. The password input screen 50 contains four horizontally rotatable fields, a1, b1, c1 and d1, and a submit button 51. The field a1 contains alphanumeric characters, “b”, “c”, “d”, “e”, “f”, “g”, “f” and “a” in sequence. The field b1 contains alphanumeric characters, “2”, “3”, “4”, “5”, “6”, “7”, “8” and “1” in sequence. The field c1 contains symbols, “?”, “?”, “*”, “*”, “%”, “@”, “@” and “%” in sequence. The field d contains alphanumeric characters, “μ”, “α”, “β”, “γ”, “δ”, “ε”, “θ” and “λ” in sequence. The field a1 in the initial password input screen 50 is selected by displaying a rectangle surrounding the field. In addition, the identity of field a1 is stored in a temporary variable.

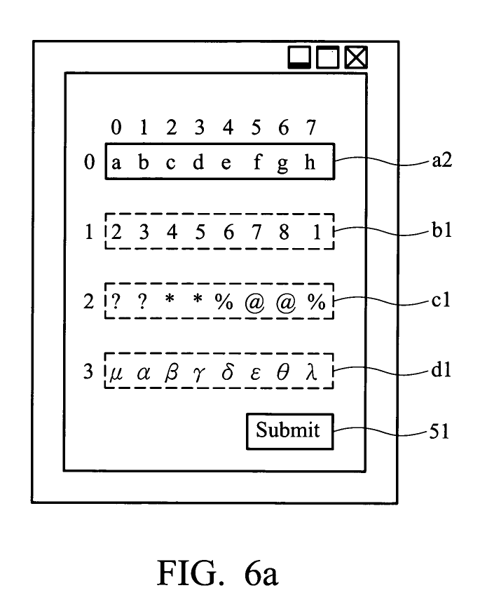

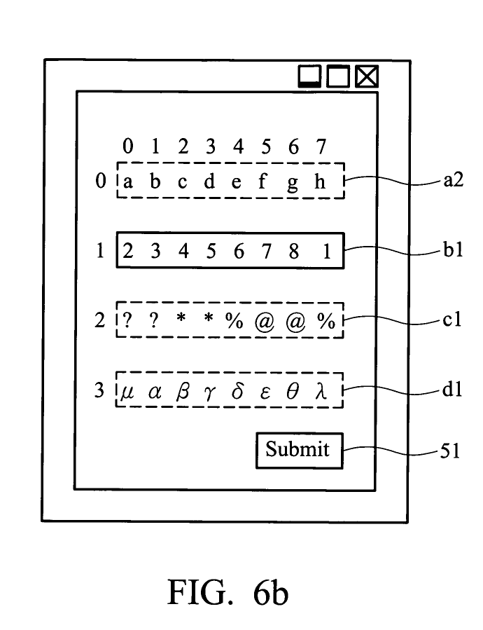

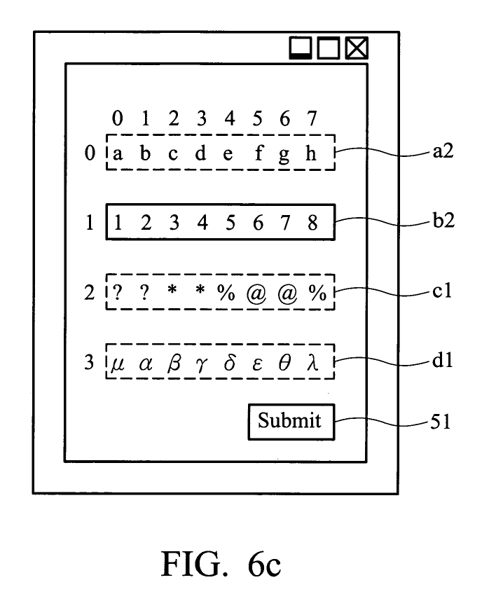

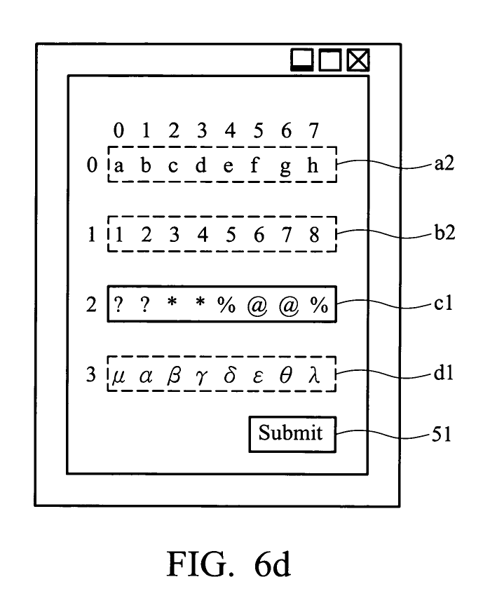

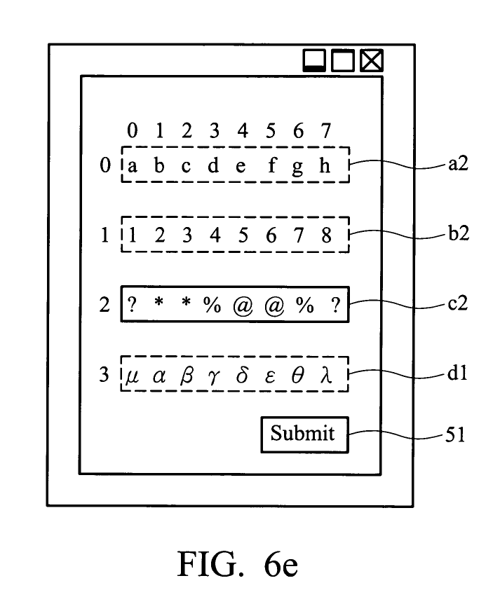

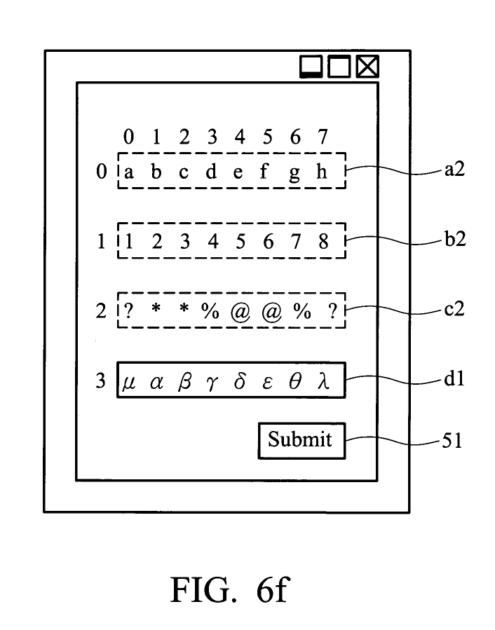

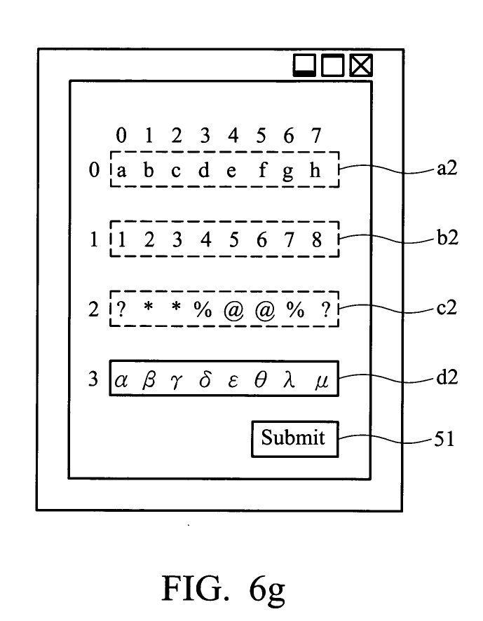

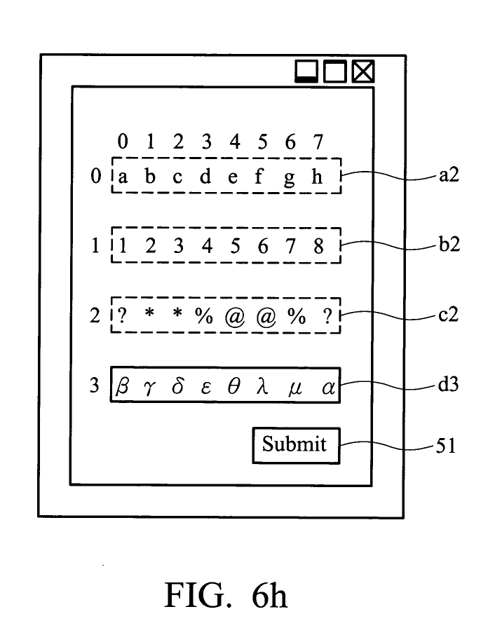

In order to move specific characters in the fields, a1, b1, c1 and d1, to the relevant positions corresponding to the password configuration records as shown in FIG. 3, a series of operations are performed. FIGS. 6a to 6h are exemplary password input screens in various aspects.

The method first receives a rotation signal to rotate characters in a selected field to the right. Thereafter, steps S422, S441, S442 and S443 are sequentially performed to rotate characters in the field a1 to the right one position, and the resulting screen is shown as FIG. 6a.

Thereafter, the method receives a selection signal to select a field next to the previous selected field. Steps S422, S431, S432 and S433 are sequentially performed to display a rectangle surrounding the field b1, as shown in FIG. 6b. The method further receives a rotation signal to rotate characters in the selected field to the right. Steps S422, S441, S442 and S443 are sequentially performed to rotate characters in the field b1 to the right one position, and the resulting screen is shown as FIG. 6c.

The method receives a selection signal to select a field next to the previous selected field. Steps S422, S431, S432 and S433 are sequentially performed to display a rectangle surrounding the field c1, as shown in FIG. 6d. The method subsequently receives a rotation signal to rotate characters in the selected field to the left. Steps S422, S441, S442 and S443 are sequentially performed to rotate characters in the field c1 to the left two positions, and the resulting screen is shown as FIG. 6e.

The method receives a selection signal to select a field under the previous selected field. Steps S422, S431, S432 and S433 are sequentially performed to display a rectangle surrounding the field d1, as shown in FIG. 6f. The method further receives two rotation signals to rotate characters in the selected field to the left. Steps S422, S441, S442 and S443 are sequentially and repeatedly performed twice to rotate characters in the field d1 to the left two positions, and the resulting screens are shown as FIGS. 6g and 6h.

Finally, the method receives a submit signal from the button 51. Step S451 is performed to acquire the password configuration records as shown in FIG. 3. Step S452 is then performed to verify that all characters in the password configuration records are displayed at relevant positions. Step S453 is performed to disable the password input screen 50, thereby allowing access to a hardware device or a software system.

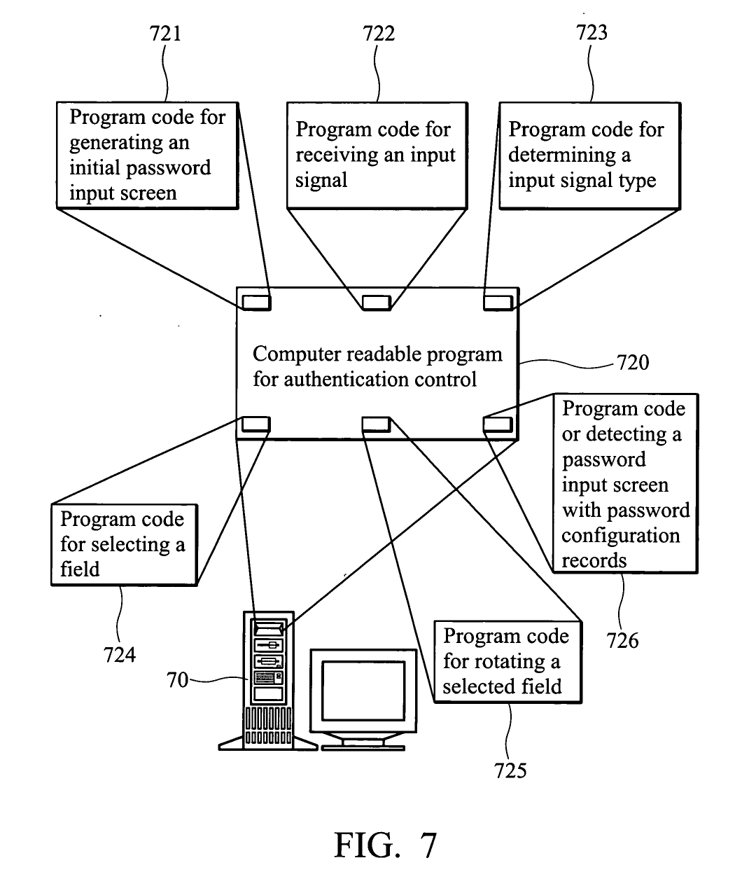

An exemplary storage medium for storing a computer program 720 that provides a computer-implemented method of authentication control is shown in FIG. 7. The storage medium 70 comprises computer readable program code embodied in the medium for use in a computer system, the computer readable program code comprising at least computer readable program code 721 for generating an initial password input screen, computer readable program code 722 for receiving an input signal, computer readable program code 723 for determining an input signal type, computer readable program code 724 for selecting a field, computer readable program code 725 for rotating a selected field, and computer readable program code 726 for detecting a password input screen with password configuration records.

Embodiments of methods and systems, or certain aspects or portions thereof, may take the form of program code (i.e., instructions) embodied in tangible media, such as floppy diskettes, CD-ROMS, hard drives, or any other machine-readable storage medium, wherein, when the program code is loaded into and executed by a machine, such as a computer, the machine becomes an apparatus for practicing the invention. Embodiments of methods and apparatus of the present invention may also be embodied in the form of program code transmitted over some transmission medium, such as electrical wiring or cabling, through fiber optics, or via any other form of transmission, wherein, when the program code is received and loaded into and executed by a machine, such as a computer, the machine becomes an apparatus for practicing the invention. When implemented on a general-purpose processor, the program code combines with the processor to provide a unique apparatus that operates analogously to specific logic circuits.

Although the present invention has been described in preferred embodiments, it is not intended to limit the invention to the precise embodiments disclosed herein. Those who are skilled in this technology can still make various alterations and modifications without departing from the scope and spirit of this invention. Therefore, the scope of the present invention shall be defined and protected by the following claims and their equivalents.

What is claimed is:

1. A system of authentication control, comprising:
a display device, configured to display a password input screen, the password input screen having a plurality of display characters, each display character being displayed at a coordinate location;
a storage device, configured to store at least one password configuration record, each password configuration record having a detection character and a coordinate data corresponding to the detection character; and
a processing unit, coupled to the display device and the storage device, configured to compare the display characters with the detection characters and the corresponding coordinate locations with the corresponding coordinate data, and determine an access status when each detection character is the same as one of the plurality of display characters and the corresponding coordinate data corresponds to the corresponding coordinate location.

2. The system as claimed in claim 1, wherein the display character is an alphanumeric character, a symbol, or an image icon, the detection character is an alphanumeric character, a symbol, or an image icon.

3. The system as claimed in claim 1, wherein the processing unit directs the display device to generate an initial password input screen, the initial password input screen comprises a plurality of horizontally/vertically rotatable fields, each field comprises the display characters, coordinate location of each display character is randomly generated, the processing unit directs the display device to select one of the fields.

4. The system as claimed in claim 2, wherein the selection of the field is shown by displaying a rectangle around the field, displaying a pointing image to the field, reversing colors of characters and background in the field, or changing colors or fonts of characters in the field.

5. The system as claimed in claim 2, wherein the processing unit receives a field selection signal with a field identity and directs the display device to select one of the fields corresponding to the field identity.

6. The system as claimed in claim 5, wherein the processing unit receives a rotation signal with a direction and directs the display device to rotate all the display characters in the selected field according to the rotation signal.

7. The system as claimed in claim 2 wherein the processing unit receives a rotation signal with a direction and directs the display device to rotate all display characters in the selected field to the same position.

8. A method of authentication control, loaded and executed by a processing unit, the method comprising:
acquiring a password input screen, the password input screen having a plurality of display characters, each display character being displayed at a coordinate location;
acquiring at least one password configuration record, each password configuration record having a detection character and coordinate data corresponding to the detection character;
determining whether each display character corresponding to the detection character is displayed at the coordinate location corresponding to the coordinate data; and
disabling the password input screen if each display character corresponding to the detection character is displayed at the coordinate location corresponding to the coordinate data.

9. The method as claimed in claim 8 wherein the display character is an alphanumeric character, a symbol, or an image icon, the detection character is an alphanumeric character, a symbol, or an image icon.

10. The method as claimed in claim 8 further comprising the steps of:
generating an initial password input screen, the initial password input screen comprises a plurality of horizontally/vertically rotatable fields, each field comprises the display characters, each of the coordinate location of the display character is randomly generated; and
selecting one of the fields.

11. The method as claimed in claim 10 wherein the selection of the field is shown by displaying a rectangle around the field, displaying a pointing image to the field, reversing colors of characters and background in the field, and changing colors or fonts of characters in the field.

12. The method as claimed in claim 10 further comprising the steps of:
receiving a field selection signal with a field identity; and
selecting one of the fields corresponding to the field identity.

13. The method as claimed in claim 12 further comprising the steps of:
receiving a rotation signal with a direction; and
rotating all the display characters in the selected field according to the direction to a predetermined position.

14. The method as claimed in claim 10 further comprising the steps of:
receiving a rotation signal with a direction; and
rotating all the display characters in the selected field according to the received signal.

15. A system of authentication control, comprising:
a display device, configured to display a password input screen, the password input screen comprising a plurality of display characters, each display character being displayed at a coordinate location;
a storage device, configured to store at least one password configuration record, each password configuration record comprising a detection character and coordinate data corresponding to the detection character; and
a processing unit, coupled to the display device and the storage device, configured to acquire all the coordinate locations corresponding to the coordinate data and the display characters thereof, compare the acquired display characters with the detection characters, and disable the password input screen if the acquired display characters are the same as the detection characters.
